(19) United States
(12) Patent Application Publication
(10) Pub. No.: US 2013/0228194 A1
(43) Pub. Date: Sep. 5, 2013

(54) Vacuum Filter System and Method with Integrated Filter Cleaning

(71) Applicant: Stuart V. Holsten, Stover, MO (US)

(72) Inventor: Stuart V. Holsten, Stover, MO (US)

(73) Assignee: EMERSON ELECTRIC CO., St. Louis, MO (US)

(21) Appl. No.: 13/409,991

(22) Filed: Mar. 1, 2012

(51) Int. Cl. A47L 9/20; A47L 9/10; B01D 46/52; B08B 1/04

(52) U.S. Cl. 134/6; 15/352; 55/495; 55/500

(57) ABSTRACT

A filter system for a vacuum cleaner may include an air intake manifold having a tubular air inlet and a tubular perforated filter cage, the filter cage having a first end coupled to the air inlet and a free second end, the air inlet having an outer surface with a seal, a filter agitator coupled to the intake manifold and arranged alongside the filter cage, the filter agitator having a cleaning surface disposed adjacent to the filter cage, and a filter holder having a first end, a longitudinally opposite second end for coupling to a filter, and at least one coupler for removably coupling the filter holder to the filter inlet of the vacuum cleaner. A method of cleaning a vacuum cleaner filter may include coupling the filter holder to the filter inlet and rotating the filter holder so that the filter rotates about the filter cage.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The invention disclosed and taught herein relates generally to vacuum cleaners, and more specifically relates to filter systems for wet/dry vacuum cleaners.

2. Description of the Related Art

Typically, when a vacuum cleaner, such as a conventional vacuum or a wet/dry vacuum, is switched “on,” the vacuum motor is energized, which in turn rotates a blower wheel. The rotating of the blower wheel causes a vacuum within the vacuum collection drum. There is typically a filter, among other components, interfaced between the blower wheel and the collection drum. When a hose, or other such attachment is coupled to the drum, this vacuum will cause air, dirt, liquids, and/or other media to be drawn from a work surface into the drum. As this “dirty” air enters the drum, some of the media particles fall to the bottom of the drum, while other media, typically the finer media particles, may contact the vacuum filter. The filter traps at least some of the particulate media, thus preventing it from being drawn out of the drum, and exhausted back into the atmosphere of the work area. It can, therefore, be readily seen that the vacuum filter must from time to be time be cleaned or removed and replaced.

Typically, to check the filter of a vacuum, a lid or some kind of access covering must first be removed from the vacuum housing in order to gain access to the filter. Then, to clean the filter, one may have to first remove the filter and clean it manually, such as by washing or striking the filter against a hard surface to dislodge accumulated debris particles. However, to remove the filter, one still must generally access it by removing a lid, panel, or other covering. Therefore, for convenience, it can be seen that it would be advantageous to be able to check, clean, and/or remove the filter using a system accessible from the exterior of the vacuum.

The invention disclosed and taught herein is directed to an improved system and method for removing, checking, and/or cleaning a filter or filter assembly of a vacuum appliance, such as a wet/dry vacuum cleaner or other conventional vacuum cleaner.

### BRIEF SUMMARY OF THE INVENTION

A filter system for a vacuum cleaner having a filter inlet may include an air intake manifold having a tubular air inlet and a tubular perforated filter cage, the filter cage having a first end coupled to the air inlet and a free longitudinally opposite second end, the air inlet having an outer surface with an annular seal, a filter agitator coupled to the intake manifold and arranged along side the filter cage, the filter agitator having a cleaning surface disposed adjacent to the filter cage, and a filter holder having a first end, a longitudinally opposite second end for coupling to a filter, and at least one coupler for removably coupling the filter holder to the filter inlet of the vacuum cleaner.

A method of cleaning a vacuum cleaner filter may include coupling the filter holder to the filter inlet and rotating the filter holder so that the filter rotates about the filter cage.

A vacuum cleaner may include a vacuum body for receiving vacuumed debris, the vacuum body including a drum and a lid, a vacuum inlet coupled to the body for allowing air and vacuumed debris to enter the body, a vacuum outlet for allowing air to exit the body, an air path between the vacuum inlet and the vacuum outlet, a filter inlet coupled to the body, and a filter system with a filter coupled to the filter inlet so that at least a portion of the filter is disposed in the air path, the filter system including an air intake manifold having a tubular air inlet and a tubular perforated filter cage, the filter cage having a first end coupled to the air inlet, the air inlet having an outer surface with an annular seal, a filter agitator arranged along side the filter cage, the filter agitator having a cleaning surface disposed adjacent to the filter cage, and a filter holder having a first end with a handle, a longitudinally opposite second end for coupling to the filter, and at least one coupler for removably coupling the filter holder to the filter inlet of the vacuum cleaner.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1A illustrates an isometric view of one of many embodiments of a vacuum appliance utilizing certain aspects of the present disclosure.

FIG. 1B illustrates a cross-sectional view of the vacuum appliance of FIG. 1, taken along line 1B-1B, illustrating one of several embodiments of a filter system utilizing certain aspects of the present disclosure.

FIG. 2 illustrates a partial cross-sectional view of the filter system of FIG. 1B showing details of the filter system itself.

FIG. 3. illustrates a top cross-sectional view of the vacuum appliance of FIG. 1B taken along line 3-3, showing the filter system of FIGS. 1A, 1B, and 2.

FIG. 4 illustrates one of many embodiments of a filter system having a manifold and utilizing certain aspects of the present disclosure.

FIG. 5 illustrates a top isometric view of one of many embodiments of a filter inlet utilizing certain aspects of the present disclosure.

FIG. 6 illustrates a bottom isometric view of the filter inlet of FIG. 5.

FIG. 7 illustrates a top isometric view of one of many embodiments of a filter holder utilizing certain aspects of the present disclosure.

FIG. 8 illustrates a side view of the filter holder of FIG. 7.

FIG. 9A illustrates a top isometric view of one of many embodiments of a filter utilizing certain aspects of the present disclosure.

FIG. 9B is a bottom isometric view of the filter of FIG. 9A.

FIG. 10 illustrates a side cross-sectional view of the filter of FIG. 9B taken along line 10-10.

FIG. 11 illustrates one of many embodiments of a filter assembly utilizing certain aspects of the present disclosure.

FIG. 12 illustrates a cross-sectional view of the embodiment of FIG. 11.

FIG. 13 illustrates a top view of one of many embodiments of a filter assembly being installed and utilizing certain aspects of the present disclosure.

FIG. 14 illustrates another top view of the filter assembly of FIG. 13 being installed.

FIG. 15 illustrates a top view of one of many embodiments of a filter system having an installed filter assembly.

FIG. 16 illustrates a top view of a filter assembly partially uncoupled for cleaning or removal and utilizing certain aspects of the present disclosure.

FIG. 17 illustrates a top view of a filter assembly being removed and utilizing certain aspects of the present disclosure.

FIG. 18 illustrates another top view of the filter assembly of FIG. 17 being removed.

FIG. 19 illustrates a side view of a filter being cleaned and utilizing certain aspects of the present disclosure.

FIG. 20 illustrates an illustration of one of many embodiments of a filter system having a cutout and utilizing certain aspects of the present disclosure.

FIG. 21 illustrates a top view of one of many embodiments of a filter system having two filter assemblies and utilizing certain aspects of the present disclosure.

FIG. 22 illustrates a top isometric view of one of many embodiments of a filter system having two filter assemblies and utilizing certain aspects of the present disclosure.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought. Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment.

Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the invention disclosed and taught herein is susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally, and may occur permanently or removably.

Applicant has created a filter system and associated method for a vacuum appliance or vacuum cleaner, such as a wet/dry vacuum cleaner (i.e., a vacuum capable of picking up both wet and dry debris material), or a conventional vacuum cleaner, which allows a user to conveniently access, clean and/or remove a filter without having to remove the lid or cover portion of the vacuum. The filter system may include a filter coupled to a filter holder, wherein the filter and holder may be removably coupled to a filter inlet on the vacuum cleaner to place the filter in a path of air that is flowing into and out of the vacuum cleaner during operation. The filter system may allow access to, or removal of, the filter by the user without having to remove the lid of the vac. The filter system may allow cleaning of the filter without first requiring removal of the filter from the vacuum.

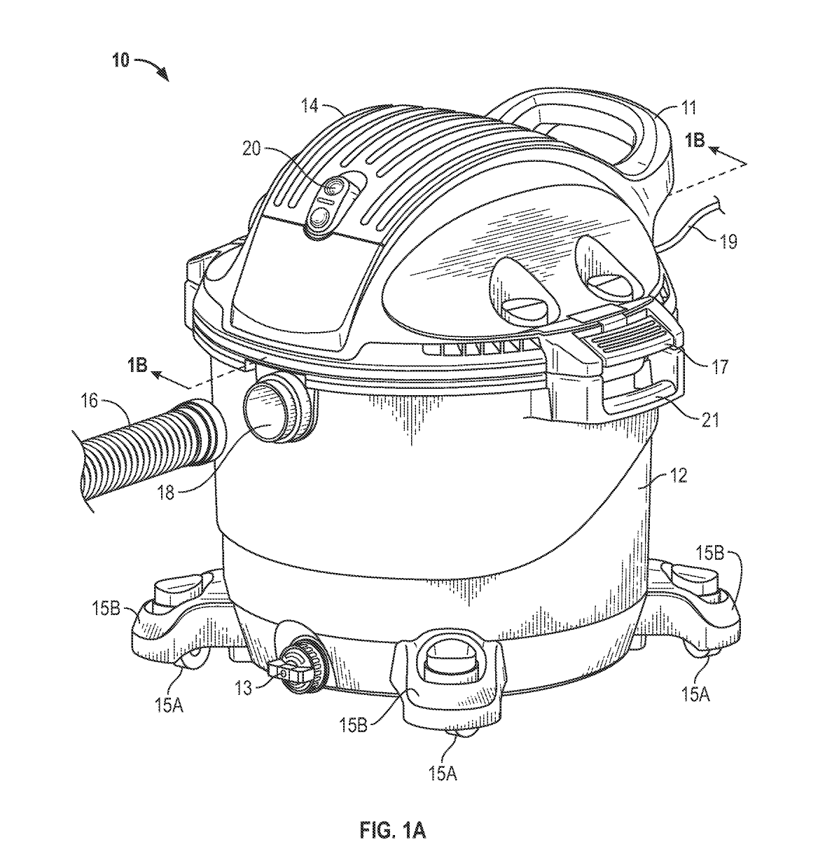

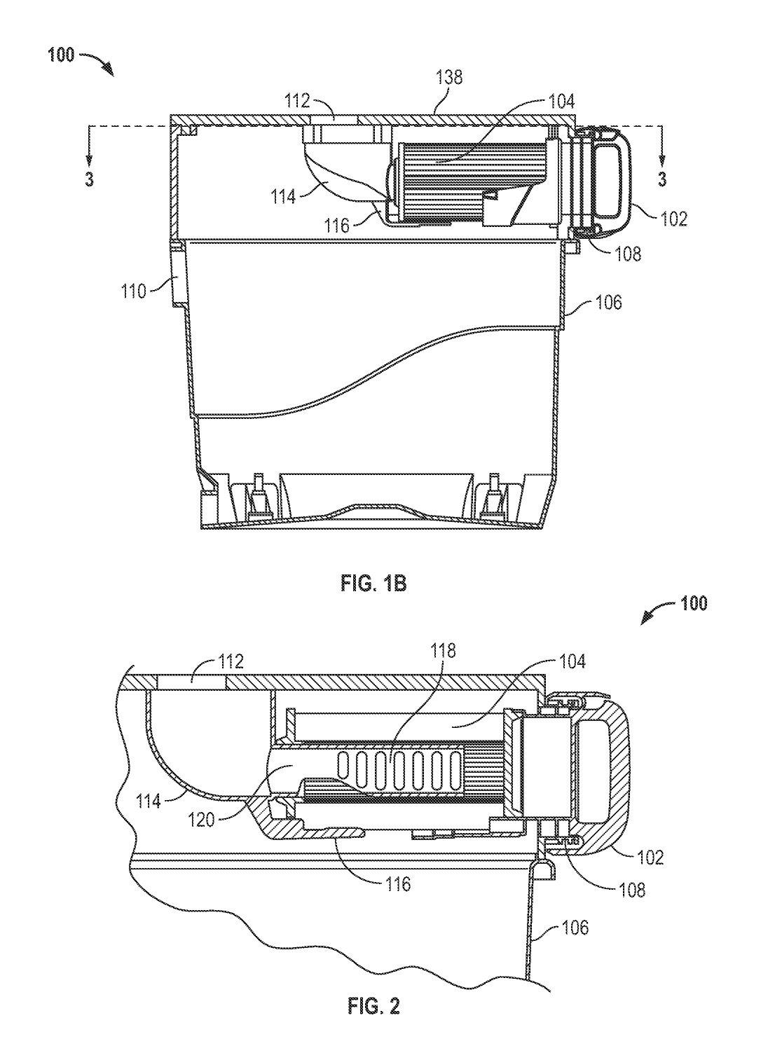

Turning now to the Figures, FIG. 1A illustrates a perspective view of an exemplary wet/dry vacuum cleaner 10 in accordance with the present disclosure which houses a vacuum filter system 100 as described in more depth herein. The vacuum 10 comprises a collection canister, or body (equivalently referred to herein as a collection drum or vacuum body) 12 having a bottom, sides, and an open top, and having a powerhead 14 releasably secured via one or more securement latches 17 over the open top of collection canister 12. The vacuum 10 may be battery powered, or powered via AC or DC electricity via power cord 19.

In accordance with aspects of the instant disclosure, collection drum 12 may be circular or oval in shape, or may be of another suitable shape as appropriate, such as square or rectangular, without limitation. Furthermore, the vacuum cleaner 10 may include a handle 21. The handle 21 may be coupled to the collection drum 12, or it may be coupled to the securement latch 17. In another embodiment, the handle 17 may be coupled to the lid 138 (as shown in FIG. 1B). The handle 17 may be used to adjust the position of the vacuum cleaner 10 through a pushing, pulling, or rotational motion.

The drum may also include a plurality of casters 15a circumscribed about the bottom portion of the collection drum 12, wherein the casters 15a may be removable or permanently fixed as appropriate for the particular vacuum appliance and its intended applications. In an exemplary and non-limiting illustrative embodiment, each of the casters 15a can include a single, rotatable wheel for allowing the collection drum 12 to laterally traverse a surface, rotate about it, or both. Each of the casters 15a may be coupled with a caster housing 15b. The caster housings 15b may include any mount, support, receptacle, protective apparatus, or the like for housing one or more casters 15a. For example, a caster housing 15b may be embodied as a “foot” to support the collection drum 12. In one embodiment, four caster housings 15b can be equally spaced around the outer perimeter of the collection drum 12 to provide stability for the vacuum 10.

Collection drum 12 may also optionally include a drain plug 13 at the bottom of the drum itself, for ease of draining liquid debris from the drum, for ease in cleaning the drum once the powerhead 14 has been removed, or for attachment to a vacuum pump accessory to aid in the removal of liquid debris from within the drum. Powerhead 14 typically has a handle means 11 formed onto or into it, as appropriate, and houses a motor and impeller assembly (not shown) for establishing vacuum pressure within the vacuum 10 when a power actuating switch 20 is engaged. A flexible vacuum hose 16 is configured so that one end can be inserted into an air inlet 18 formed in the front portion of the powerhead 14 or formed into the drum 12 and in fluid connection with the powerhead 14 within the vacuum itself. In one embodiment of the present disclosure, hose 16 is simply friction-fitted into inlet port 18. Similarly and equally acceptable, hose 16 may be lock-fitted into inlet port 18 as appropriate.

For purposes of clarity and understanding, one or more of these components may not be specifically described or shown while, nevertheless, being present in one or more embodiments of the invention, such as in a commercial embodiment, as will be readily understood by one of ordinary skill in the art.

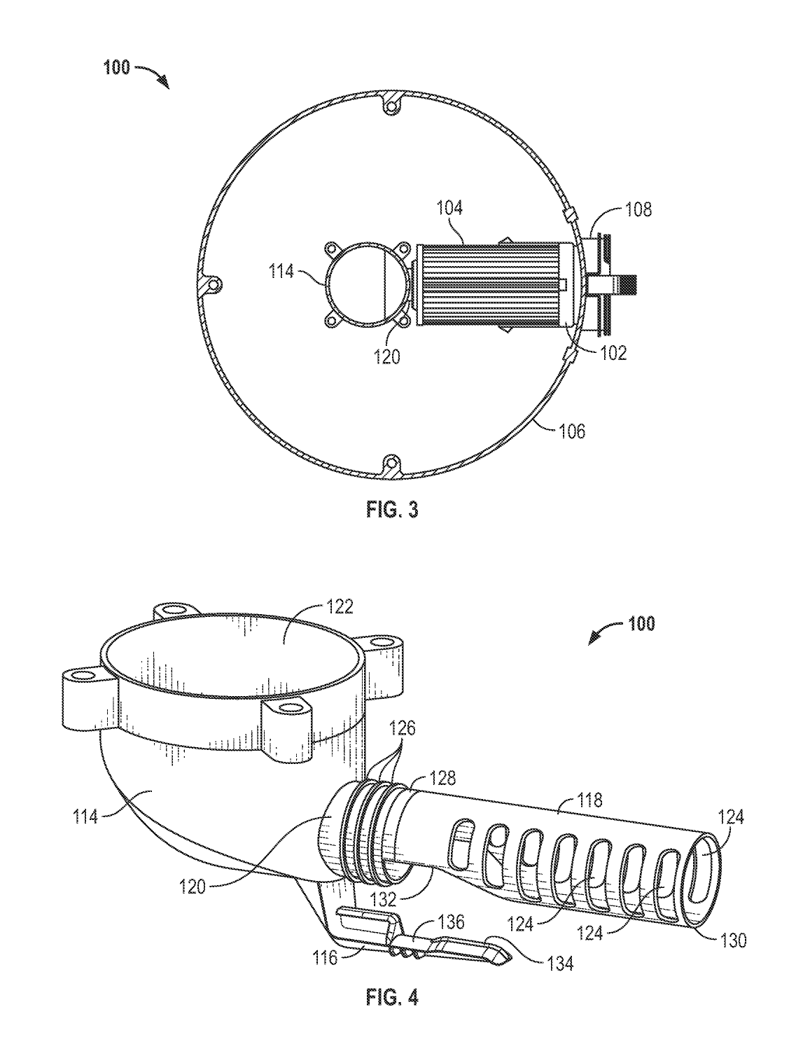

FIG. 1B is an illustration of one of many embodiments of a filter system 100 utilizing certain aspects of the present invention. FIG. 2 is a cross-sectional view of the filter system of FIG. 1B. FIG. 3 is a top view of the filter system of FIGS. 1B and 2, taken along line 3-3 of FIG. 1B. FIGS. 1-3 will be described in conjunction with one another. Filter system 100 may include one or more components for filtering vacuumed air. For example, filter system 100 may include a filter holder 102 for coupling a filter 104 to a vacuum body 106, such as to a filter inlet 108. Filter inlet 108 may be located anywhere on vacuum cleaner body 106, for example, on the exterior side or top, so that filter 104 may be disposed within a path of air moving from an air inlet port 110 to an air outlet 112 within vacuum cleaner body 106.

Filter system 100 may also include a manifold 114, such as an air intake manifold, for example, for routing air, such as filtered air. Manifold 114 may further include a cleaning device 116, for example, an agitator, coupled thereto for removing debris from filter 104 during cleaning, as will be described in more detail below. Manifold 114 may, but need not, include a filter cage 118, such as a perforated tube of any appropriate shape (e.g., cylindrical, generally cylindrical, or rectangular), coupled thereto for directing filtered air from filter 104 to an inlet 120 of manifold 114 or, as another example, for supporting filter 104, separately or in combination. One or more of these components may now be described in more detail.

FIG. 4 is an illustration of the details of manifold 114 in accordance with embodiments of filter system 100 of the present invention. Manifold 114 includes an inlet 120 for receiving air and an outlet 122 for exhausting air during normal vacuum cleaner operations. For example, air flowing through one or more openings 124, such as perforations, in filter cage 118 may move into inlet 120, through manifold 114, and out of outlet 122 during vacuum operation. However, as will be readily understood by one of ordinary skill, air may likewise flow in the opposite direction through manifold 114 (i.e., into outlet 122 and out of inlet 120) as required by a particular application. For example, the filter system 100 is capable of receiving a back-flushed airflow to clean the filter 104 (as shown in FIG. 3). In this configuration, the direction of airflow can be reversed to flow though the slots 124 of the filter cage 118.

Manifold 114 may be formed from any material and in any manner, for example, manifold 114 may be machined, molded, cast, or otherwise formed from any number of polymeric, plastic materials, metal, aluminum, composite, alloy or another material, in whole or in part. Inlet 120 may be tubular, and may have one or more seals 126, such as sealing ribs or gaskets, coupled to an inner or outer surface thereof. In the embodiment of FIG. 4, three seals 126 are shown for illustrative purposes, each of which is coupled to the outer surface of inlet 120 extending radially outwardly therefrom.

While three seals 126 are shown in FIG. 4, one or more embodiments of the present invention may have one, two, four, or any number of seals required by a particular application. Inlet 120 may be coupled to manifold 114, or formed integrally therewith, in whole or in part, and may, but need not, include structure for coupling with filter 104. Further, while not shown directly in the Figure for purposes of clarity, the manifold 114 may also include a number of formed threads near the interface of inlet 120 and the exterior surface of outlet 122, so as to allow a filter device to be threadably attached to the filter cage 118.

Filter system 100 may, but need not, include a filter cage 118 for routing airflow into inlet 120 of manifold 114 during vacuum cleaner operations. Filter cage 118 may, but need not, support filter 104. Filter cage 118 may be tubular, and may have one or more holes 124, such as perforations, for allowing air to flow throughout in any direction. The one or more holes 124 may be any size or shape and may be arranged in any manner required by a particular application. Filter cage 118 may have any cross-sectional shape or size, such as cylindrical, oval, or rectangular, and may preferably be at least partially cylindrical. Filter cage 118 may be configured to receive a filter thereon or thereabout (e.g., as shown in FIG. 2), thereby allowing fluid communication between the filter, the interior of filter cage 118, and manifold 114. A first end 128 of filter cage 118 may be coupled to manifold 114, such as to inlet 120, in any manner, such as coupled thereto removably, permanently, or otherwise, or formed integrally therewith, such as by molding, casting, or another method.

Filter cage 118 may have a second free end 130, such as for receiving a filter thereon or otherwise coupling to a filter. Filter cage 118 may include a cutout 132 region, such as a void, opening, or space, for allowing a user to manipulate the position of a filter coupled to filter cage 118, for example, during cleaning, as will be further described below. Cutout 132 may be formed in any location and in any manner such as, for example, by reducing the cross-sectional area of filter cage 118 over a portion of its length proximate to first end 128, which may be any portion of the length of filter cage 118 required by a particular application. For example, cutout 132 may be formed so that at least a portion of a filter may be placed therein, as will be described in greater detail below. Cutout 132 may be closed, perforated, or open on its radially outer surface (e.g., on the surface facing cleaning device 116 as illustrated in FIG. 4). Filter cage 118 may be formed from any material and in any manner, for example, filter cage 118 may be machined, molded, cast, or otherwise formed from any suitable polymer or plastic material, metal, aluminum, composite, alloy, or another material, in whole or in part.

With continuing reference to FIG. 4, filter system 100 may include a cleaning device 116, such as an arm, extension, or agitator, for dislodging media from a filter during cleaning, which will be further described below. Cleaning device 116 may have any length, width, or size required by a particular application, and may be coupled to manifold 114 so that cleaning device 116 extends along side filter cage 118. Cleaning device 116 may, but need not, be parallel to at least a portion of filter cage 118. For example, in one embodiment, cleaning device 116 can be disposed such that it lies substantially parallel with respect to the filter cage 118 along a longitudinal axis extending outwardly from the outlet 120 of the manifold 114. A component remains “substantially parallel” with respect to another component if the angle formed between each components' longitudinal axis is no more than 20 degrees. The term, “substantially parallel” can include parallel as well.

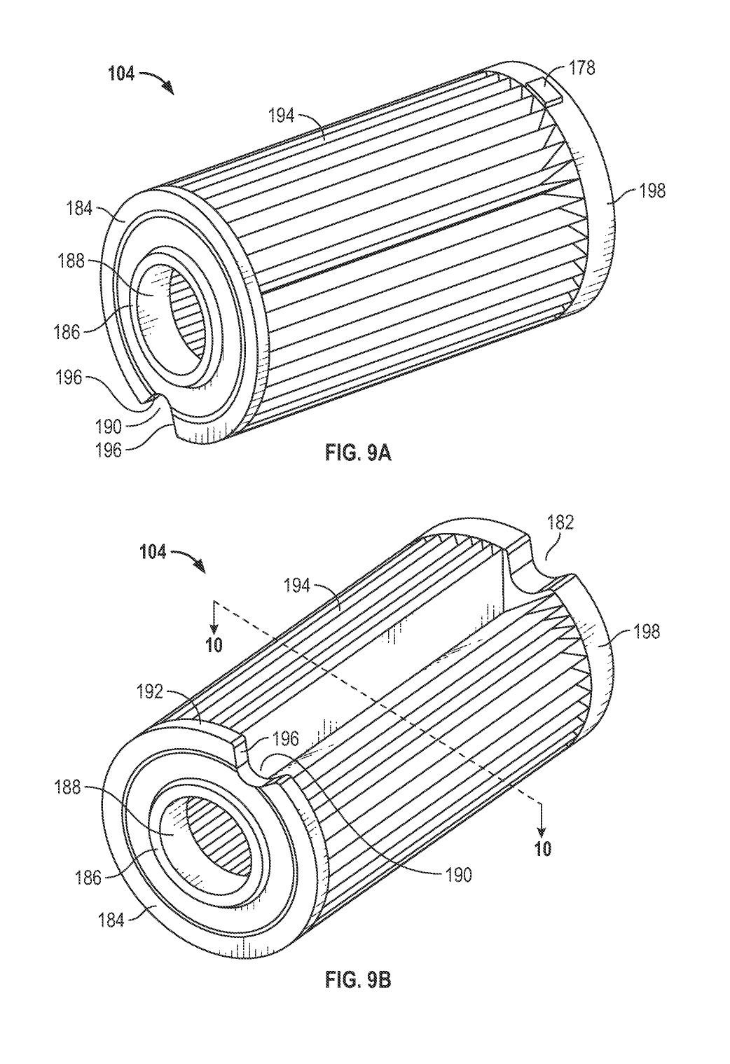

Cleaning device 116 and filter cage 118 may, but need not, have the same length, and cleaning device 116 may be spaced far enough from filter cage 118 to allow a filter 104 (e.g., as shown in FIG. 2) to be disposed there between. Cleaning device 116 may include a cleaning surface 134 for cleaning filter 104. Cleaning surface 134, or another portion of cleaning device 116, may, but need not, contact filter 104, for example, to dislodge debris stuck thereto. Cleaning surface 134 may be any surface on cleaning device 116 required by a particular application, and may be flat, smooth, contoured, bumpy or, as other examples, may include bristles or teeth for cleaning. Cleaning device 116 may include a rubbing surface 136, such as a buffer or bumper, for defining the position of cleaning surface 134 relative to a surface to be cleaned, as will be further described below. For example, rubbing surface 136 may contact an abutting surface or edge, such as a portion of a filter (e.g., as shown in FIGS. 9A and 9B), thereby defining the extent to which cleaning surface 134 may contact the outer surface of the filter, such as to at least reduce any damage to the filter that may occur, for example, due to repeated cleaning.

Cleaning device 116 may be formed from any material and in any manner, for example, cleaning device 116 may be machined, molded, cast, or otherwise formed from plastic, metal, aluminum, composite, alloy, or another material, in whole or in part. Cleaning device 116 may be coupled to manifold 114, or any portion thereof, in any manner, such as formed integrally therewith or coupled thereto, in whole or on part. Cleaning device 116 may preferably be rigidly coupled to manifold 114, for example, so that cleaning device 116 may not move or rotate relative to a filter during cleaning, resisting any temporary displacement resulting from forces applied to cleaning device 116 during cleaning (e.g., from torque, friction, or the like), as will be readily understood by one of ordinary skill.

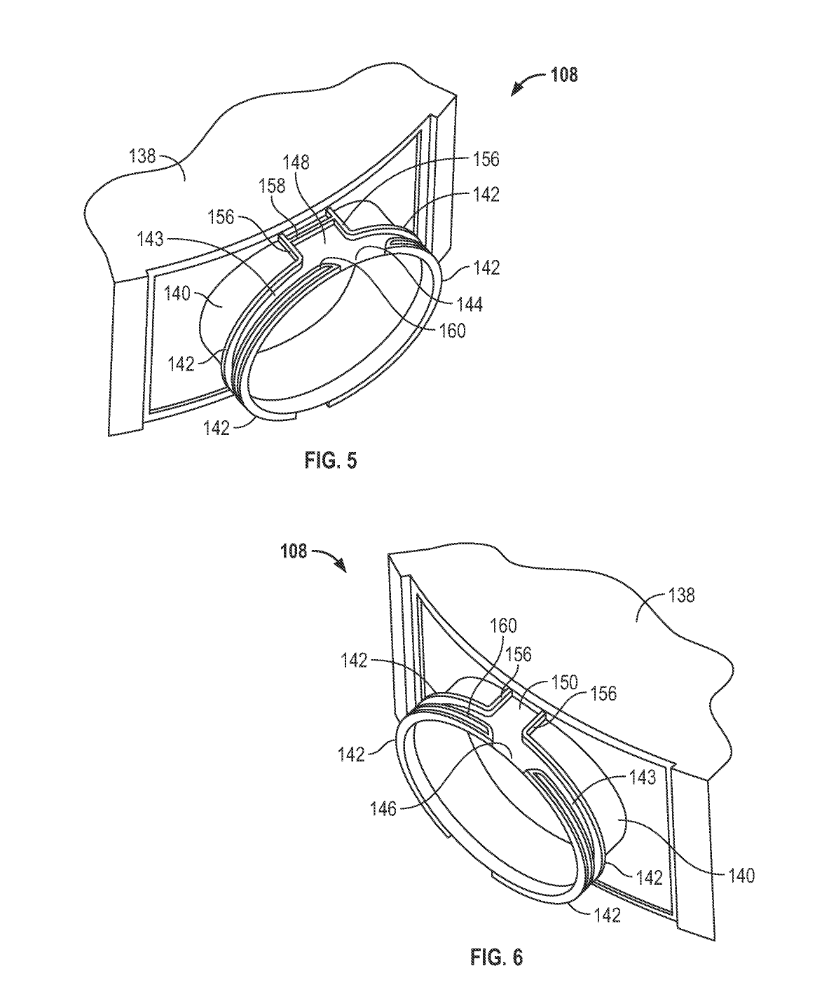

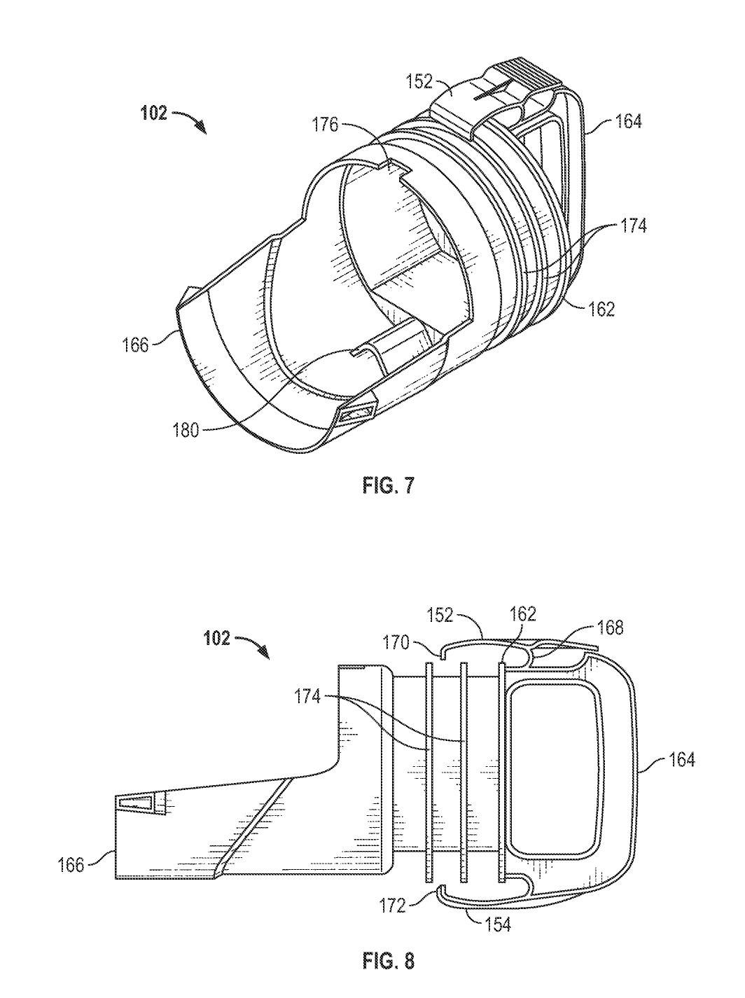

FIG. 5 is a top isometric view of one of many embodiments of a filter inlet 108 utilizing certain aspects of the present invention. FIG. 6 is a bottom isometric view of the filter inlet of FIG. 5. FIGS. 5 and 6 will be described in conjunction with one another. Filter system 100 may include a filter inlet 108 coupled to vacuum cleaner body 106 (e.g., as shown in FIGS. 1-3) for allowing one or more other components of the system, such as a filter, to be inserted in, or removed from, vacuum cleaner body 106, in whole or in part. For example, filter inlet 108 may be a tubular fitting coupled to, or formed integrally with, vacuum cleaner body 106 at any location required by a particular application, and may preferably be coupled to the vacuum cleaner lid 138. Filter inlet 108 may include structure for coupling to filter holder 102 (e.g., as shown in FIGS. 7 and 8), which will be further described below.

Filter inlet 108 may include a tubular extension 140 having an inner surface and an outer surface, and one or more ribs, which may be annular, segmented, or any other shape, coupled to the outer surface and extending radially outwardly therefrom. For example, filter inlet 108 may include guide ribs 142, which may define one or more slots or spaces, such as cleaning slot 143, for communicating with one or more structures on filter holder 102, as will be further described below. Filter inlet 108 may include one or more openings or paths, such as latch opening 144 and guide member opening 146, for communicating with one or more structures, such as couplers, on filter holder 102, as will be further described below. Each opening 144 and 146 may, but need not, be the same size, and may preferably be different sizes, for example, for at least partially defining an orientation for communication with filter holder 102. Filter inlet 108 may include latch slot 148 and guide slot 150, for example, for receiving a latch 152 and guide member 154 (e.g., as shown in FIGS. 7 and 8).

Each slot 148 and 150 may be formed in any manner required by a particular application, such as between alignment ribs 156 for aligning filter holder 102 with filter inlet 108. Filter inlet 108 may include a latch rib 158 for removably engaging latch 152 on filter holder 102, for example, when filter holder 102 is coupled to filter inlet 108, as will be further described below. Filter inlet 108 may include one or more stop ribs 160, which may be formed separately or integrally with one or more guide ribs 142, for example, for aligning filter holder 102 with guide ribs 142 for cleaning a filter. While latch slot 148 and guide slot 150 are shown in the embodiment of FIGS. 5 and 6 to be on the top and bottom of filter inlet 108, respectively, for illustrative purposes, slots 148, 150 can be located anywhere on filter inlet 108 relative to one another as required by a particular application.

Similarly, each component of filter inlet 108, such as guide ribs 142, openings 144, 146, and ribs 156, 158, and 160 can have any form and can be arranged in any manner required by a particular application for communication with filter holder 102, as will be further described below. For example, in at least one embodiment, there may be a loose fit between filter holder 102 and one or more slots or grooves on filter inlet 108. Filter inlet 108, and any component thereof or thereon, may be formed from any material and in any manner required by a particular application. For example, filter inlet 108 may be machined, molded, cast, or otherwise formed from plastic, metal, aluminum, composite, alloy or another material, in whole or in part, as will be understood by one of ordinary skill.

FIG. 7 is a top isometric view of one of many embodiments of a filter holder 102 utilizing certain aspects of the present invention. FIG. 8 is a side view of the filter holder 102 of FIG. 7. FIGS. 7 and 8 will be described in conjunction with one another. Filter system 100 may include a filter holder 102 for coupling to a filter 104 (e.g., as shown in FIGS. 9A and 9B) and for coupling the filter within the system. Filter holder 102 may have a first end 162 that may, but need not, have a handle 164 for allowing a user to manipulate the holder and/or other components, for example, during installation, removal, or cleaning of a filter in the system. Handle 164 may be any shape or size required by a particular application, such as D-shaped (as shown), L-shaped, or another shape. Filter holder 102 may have a second end 166 for coupling to a filter, as further described below.

As mentioned above, filter holder 102 may include structure, such as one or more components, for communicating with filter inlet 108, such as a latch or guide. For example, latch 152 may communicate with latch opening 144, latch slot 148, and latch rib 158 during coupling or uncoupling filter holder 102 and filter inlet 108, as will be further described below. Latch 152, which may, but need not, be biased in the closed position in its resting state, may pivot about latch support 168 for removably coupling latch hook 170 with filter inlet 108, such as to latch rib 158 (e.g. as shown in FIG. 5).

As another example, guide member 154 may communicate with guide member opening 146 and guide slot 150 during coupling or uncoupling filter holder 102 and filter inlet 108, for example, for alignment purposes. As will be further described below, latch hook 170 and guide member hook 172 may communicate with one or more slots, such as guide slot 143, formed between guide ribs 142 (e.g., as shown in FIGS. 5 and 6), for example, during cleaning of a filter. Filter holder 102 may include one or more seals 174, which may be any type of seals, such as sealing ribs or gaskets, for sealingly engaging filter inlet 108 when filter holder 102 is coupled to filter inlet 108. While seals 174 are shown in the embodiment of FIGS. 7 and 8, to be coupled to filter holder 102, seals 174 may alternatively be coupled to filter inlet 108, or both, in whole or in part, as will be readily understood by one of ordinary skill.

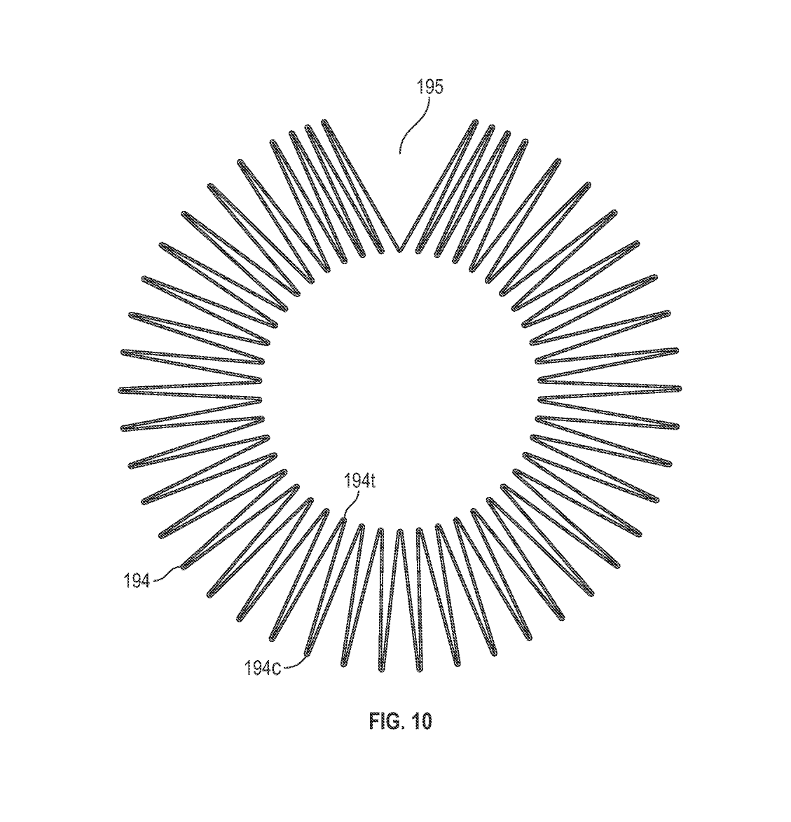

Filter holder 102 may include one or more components for coupling a filter 104 (e.g., as shown in FIGS. 9A, 9B, and 10) thereto or therewith. For example, filter holder 102 may include one or more notches 176 for communicating with one or more tabs 178 (e.g., as shown in FIG. 9A) on filter 104. As another example, filter holder 102 may include one or more guides 180, such as a rail, bar, or other device for communicating with filter 104, such as to position or support filter 104 on filter holder 102 as required by a particular application. A guide 180 may function generally as latch 152, described above, or as another example, guide 180 may be more rigid and need not lock or snap into place. For example, filter 104 may have a slot 182, such as a channel or groove, for communicating with guide 180. The slot 182 may have a width as measured as a distance along the outer perimeter of second end 198 (as shown in FIG. 9B).

Likewise, slot 190 may have a width as measured as a distance along the outer perimeter of first end 184 (as shown in FIG. 9B). For example, the width of slot 190 as depicted in FIG. 9B may be measured by the radial distance between the portion of the groove in the first end 184 as measured along the outer perimeter of the first end 184. In another embodiment, the width of slot 190 can include the linear distance between the groove in the first end 184. The width measurements for the slot 182 may be determined in a similar fashion with respect to the second end 198.

Although shown in FIGS. 7 and 8 as described above and FIGS. 9A and 9B as further described below for illustrative purposes, it is also contemplated by the present invention that, in at least one embodiment, a filter may, but need not, have a notch and guide while a filter holder has a complementary tab and slot, for example, for keying the filter and filter holder, as will be readily understood by one of ordinary skill in the art. In any event, the present disclosure contemplates coupling a filter and a holder, and other components of the system, for the purposes described herein regardless of the number, size, or arrangement of couplers, if any, such as those described above, wherein each of those shown in the FIGS. for illustrative purposes is one of many that may be used and are contemplated by the present invention. Filter holder 102, and any component thereof or thereon, may be formed from any material and in any manner, for example, filter holder 102 may be machined, molded, cast, or otherwise formed from plastic, metal, aluminum, composite, alloy, or another material, in whole or in part, as will be understood by one of ordinary skill.

FIG. 9A is a top isometric view of one of many embodiments of a filter 104 utilizing certain aspects of the present invention. FIG. 9B is a bottom isometric view of the filter of FIG. 9A. FIG. 10 illustrates a side cross-sectional view of the filter of FIG. 9B taken along line 10-10. FIGS. 9A, 9B, and 10 will be described in conjunction with one another. Filter system 100 may include a filter 104 for filtering debris or other media from air flowing through the system. The embodiment of filter 104 shown in FIGS. 9A, 9B, and 10 is but one of many, and is shown herein only for illustrative purposes.

The filters, such as filter 104, suitable for use in the assemblies of the present disclosure may be of the pleated type as illustrated, or may be non-pleated, and may be made of any number of suitable filtration materials for filtering/removing at least some debris or other media out of the air passing there through, exemplary materials including but not limited to paper; cloth; glass-fiber materials; split-fiber materials; solution-spun fibers and materials made from such fibers; felt materials; natural fiber filter material; expanded polytetrafluoroethylene (PTFE) membranes; expanded ultra high molecular weight polyethylene (PE) membranes and materials; melt-blown media, such as melt-blown polypropylene (PP) or melt-blown polyethyelene (PE); microporous open cell polymers, such as polyurethane foam; poly(ethylene terephthalate) (PET), or polyphenylene sulfide (PPS) based materials, as well as copolymer-based materials thereof; HEPA-type materials and related fiber or randomly-arranged fiber materials (high-efficiency particulate air (HEPA) filters being those filters which can remove at least 99.97% of airborne particles 0.3 micrometers (μm) in diameter) in accordance with NIOSH requirements; triboelectrified media and materials, and the like, any of which may be treated so as to be hydrophobic and/or have mold and mildew preventative characteristics. Such treatments may be especially desirable for those filter assemblies manufactured for use in wet/dry vacuum cleaners.

Further, as illustrated more clearly in FIG. 10, the filter element 194 of the filter 104 may be folded or pleated to form a structure with a plurality of crests 194c and a plurality of troughs 194t to increase the surface area of the filter 104. This folding increases the area of the filter that is in contact with the airstream during vacuum appliance operation, thus effectively improving the filtration without decreasing the airflow. This structure can be formed in a continuous fashion from a single, unitary, or monolithic piece of material, or in the alternative, it could be formed by coupling two or more pieces of material to form the filter 104. From a cross-sectional view of the filter 104, the plurality of crests 194c can be configured to form an outer perimeter of the filter 104 in a circular or semi-circular (such as an ellipse or oval-shaped) configuration. Likewise, the plurality of troughs 194t can be configured to form an inner perimeter of the filter 104 in a circular or semi-circular configuration with a smaller radius as compared to the perimeter circumscribed by the plurality of crests 194c.

Preferably, in accordance with one aspect of the present disclosure, and regardless of which material is used to form filter 104, the filter material may be folded into multiple pleats and formed into a cylindrical (i.e., tube-like shaped) or generally cylindrical shape having a “rippled” or “pleated” appearance, so as to increase the exposed surface area. For example, the filter 104 can be formed into a cylindrical shape by configuring the plurality of crests 194c to circumscribe the outer perimeter of a circle. Similarly, the filter 104 can be formed into a generally cylindrical shape.

A component is considered “generally cylindrical” if a cross-sectional area of the component circumscribes the outer perimeter of an oval, ellipsis, or any other polygon or shape with a semi-circular circumference with a major axis and minor axis that differ by no more than 20%. In an exemplary and non-limiting illustrative embodiment, the filter 104 may be considered “generally cylindrical” if its plurality of crests 194c circumscribe the outer perimeter of an oval, ellipsis, or any other polygon or shape with a semi-circular circumference with a major axis of 4 inches, and a minor axis of 3 inches. The term “generally cylindrical” can include cylindrical as well.

The filter element 194 can be flexed, manipulated, or displaced to form a filter cavity 195 by increasing the distance between two adjacent crests of the plurality of crests 194c. For example, two pleats can be spread apart to form a wedge-like shape as depicted in FIG. 10. In one example, the filter element 194 can take the form of a generally cylindrical shape when configured in a wedge-like shape. In another embodiment, the pleats can be repositioned to form a filter cavity 195 of other suitable shapes and sizes. By forming a filter cavity 195 through this described displacement, the filter element 194 can be configured such that a cavity is formed between the notch formed by or between the slots 182 and 190 (as shown in FIG. 9B).

The filters may also have a variety of porosities, or pore size distributions, depending upon the desired air flow permeability to be achieved. Exemplary porosities include, but are not limited to, about 1 micron, about 3 micron, and about 10 microns, as well as porosities greater than or less than these values, e.g., about 0.1 microns, and about 15 microns. In at least one embodiment, filter 104 may have a first end 184 for coupling to manifold 114. For example, first end 184 may have an opening 186 for coupling with filter cage 118 and to manifold inlet 120. In at least one embodiment, the interior surface 188 of first end 184 may sealingly engage manifold inlet 114, such as by communicating with the one or more seals 126 on manifold inlet 114 (e.g., as shown in FIG. 4).

As described above, filter 104 may include one or more components for communicating with or coupling to filter holder 102, for example, notch 178 and slot 182 formed on second end 198 of filter 104. First end 184 of filter 104 may include a second slot 190, such as a groove or path, for communicating with cleaning device 116, for example, for receiving cleaning device 116 therein when filter 104 is coupled to manifold inlet 120 so that cleaning device 116 is disposed adjacent to filter element 194 in such a manner that may or may not result in these two elements physically contacting one another.

As shown in FIGS. 9A and 9B, slots 182 and 190 may, but need not, form a continuous path along the length of filter 104. First end 184 of filter 104 may include a buffer surface 192 for communicating with rubbing surface 136 of cleaning device 116, for example, to position at least a portion of filter element 194 relative to cleaning device 116 or cleaning surface 134, as will be further described below. For example, during cleaning of filter 104, filter 104 may be rotated about its central longitudinal axis adjacent or proximal to cleaning device 116, so that rubbing surface 136 contacts at least one of sides 196 of slot 190 (depending on the direction of rotation) and continues along buffer surface 192 as filter 104 rotates, for example, to position cleaning surface 134 for cleaning element 194, which may be any position required by a particular application.

The buffer surface 192 can be formed of any material adapted to communicate or make contact with rubbing surface 136 of cleaning device 116. For example, the buffer surface 192 can be formed of plastics, rubbers (natural or synthetic), or any other synthetic or semi-synthetic organic solid or polymer, such as polyurethane, or the like. In an exemplary and non-limiting illustrative embodiment, the buffer surface 192 can include the outer surface of filter 104 composed, at least in part, of urethane.

First end 184 and second end 198 of filter 104 may, but need not, be made from a flexible material, such as urethane, which may allow filter 104 to be removably coupled to filter holder 102 with a friction fit. While first end 184 may include an opening 186, as described above, second end 198 may, but need not, be closed (i.e., having no central opening therein), which may help create a proper seal with filter holder 102, prevent dust and debris from entering inside the filter, or, as another example, may prevent the need for additional parts, such as a filter plate (not shown).

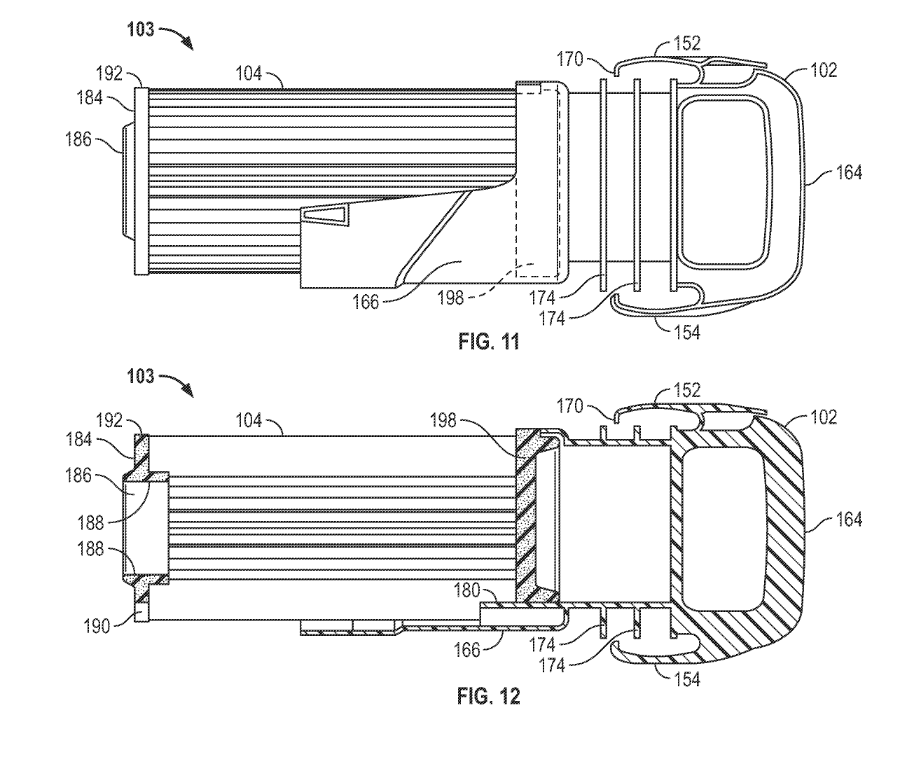

FIG. 11 illustrates of one of many embodiments of a filter assembly 103 utilizing certain aspects of the present invention. FIG. 12 is a cross-sectional view of the embodiment of FIG. 11. FIGS. 11 and 12 will be described in conjunction with one another. At least one method of practicing the present invention may now be described. Filter 104 may be coupled to filter holder 102 to form a filter assembly 103, for example, by coupling second end 198 of filter 104 to second end 166 of filter holder 102. Filter 104 may be coupled to filter holder 102 in any manner, such as by force fit, friction fit, or as another example, using fasteners, such as screws.

In at least one embodiment, one or more couplers, which may, but need not, be complementary couplers, may communicate to align or support one or more components of filter assembly 103, such as, for example, tabs and notches, grooves and rails or, as another example, one or more fasteners may be used, such as screws, brads, hook and loop material, or the like, singularly or in combination. For example, one or more couplers may, but need not, be used to key filter 104 and filter holder 102 so that filter 104 may only be coupled to filter holder 102 when the two components are in particular positions relative to one another. For example, one component may have a tab that fits in a notch on the other component to define, in whole or in part, the coupling thereof as required by a particular application.

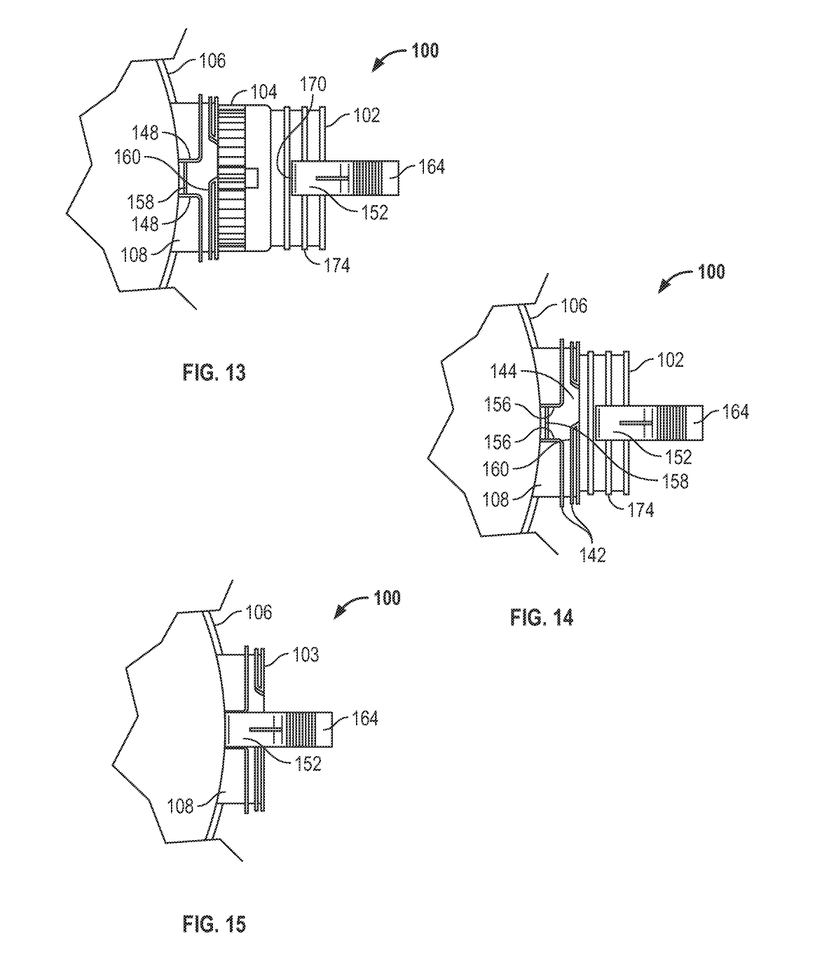

FIG. 13 is a top view of one of many embodiments of a filter assembly 103 being installed. FIG. 14 is another top view of the filter assembly 103 of FIG. 13 being installed. FIG. 15 is a top view of one of many embodiments of a filter system 100 having an installed filter assembly 103. FIGS. 13-15 will be described in conjunction with one another. With further reference to FIGS. 11 and 12, in conjunction with FIGS. 1-3 and 13-15, filter assembly 103 may be installed, for example, by coupling filter holder 102 to filter inlet 108, which may thereby dispose at least a portion of filter 104 inside of vacuum cleaner body 106, for example, so that air in the system may pass through filter element 194. In at least one embodiment, a user may grasp handle 164 and position filter assembly 103 so that first end 184 of filter 104 is proximate to filter inlet 108 (e.g., as shown in FIGS. 5-6).

Filter 104 may slide through filter inlet 108 and into vacuum cleaner body 106 (FIG. 13) so that second end 130 of filter cage 118 may slide through opening 186 and into the interior of filter 104. Filter 104 may slide over filter cage 118 so that first end 184 of filter 104 may contact and begin to slide over inlet 120 of manifold 114. As filter assembly 103 approaches the fully installed, or “seated,” position (e.g., as illustrated in FIG. 14), latch 152 may be aligned with latch opening 144 and guide member 154 may be aligned with guide member opening 146 on filter inlet 108. Latch 152 and guide member 154 may communicate with latch opening 144 and latch slot 148, and guide member opening 146 and guide slot 150, respectively, and alignment ribs 156, singularly or in combination, to guide filter holder 102 and filter 104 into place.

As filter assembly 103 further approaches the final installed position (e.g., as illustrated in FIG. 15), latch 152 may communicate with latch rib 158, for example, by latch hook 170 “snapping” or locking into position so that filter assembly 103 may be securely and removably coupled within filter system 100. Opening 186 in first end 184 of filter 104 may slide over inlet 120 of manifold 114 and interior surface 188 may sealingly engage the one or more seals 126 on inlet 120. Also, or alternatively, the one or more seals 174 on filter holder 102 may sealingly engage an interior surface of filter inlet 108 and cleaning device 116 may slide into slot 190 of filter 104.

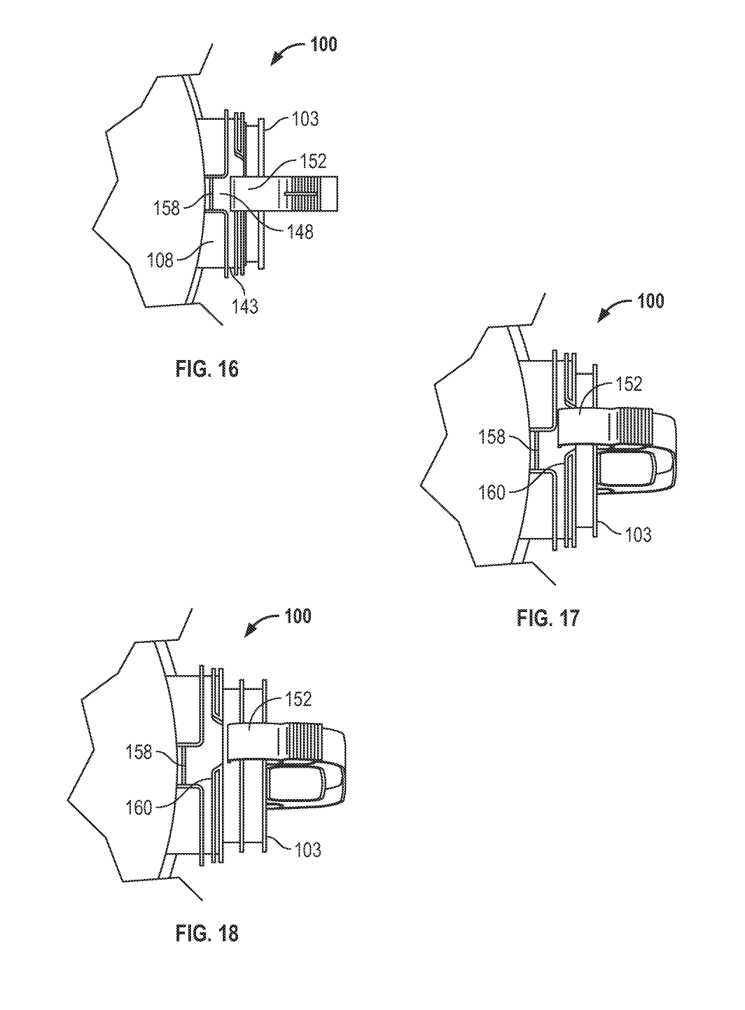

With reference to FIG. 14, one of ordinary skill having the benefit of this disclosure will understand that there are several ways of aligning and coupling filter holder 102 and filter inlet 108. For example, latch 152 may be aligned with latch opening 144 without being depressed (e.g., as shown in FIG. 18) as filter holder 102 approaches latch opening 144 during installation so that latch hook 170 passes through latch opening 144 and in between guide ribs 142. Then, filter assembly 103 may be rotated to align latch 152 with latch slot 148 (e.g., as shown in FIG. 16) so that latch hook 170 may pass between alignment ribs 156 and into communication with latch rib 158.

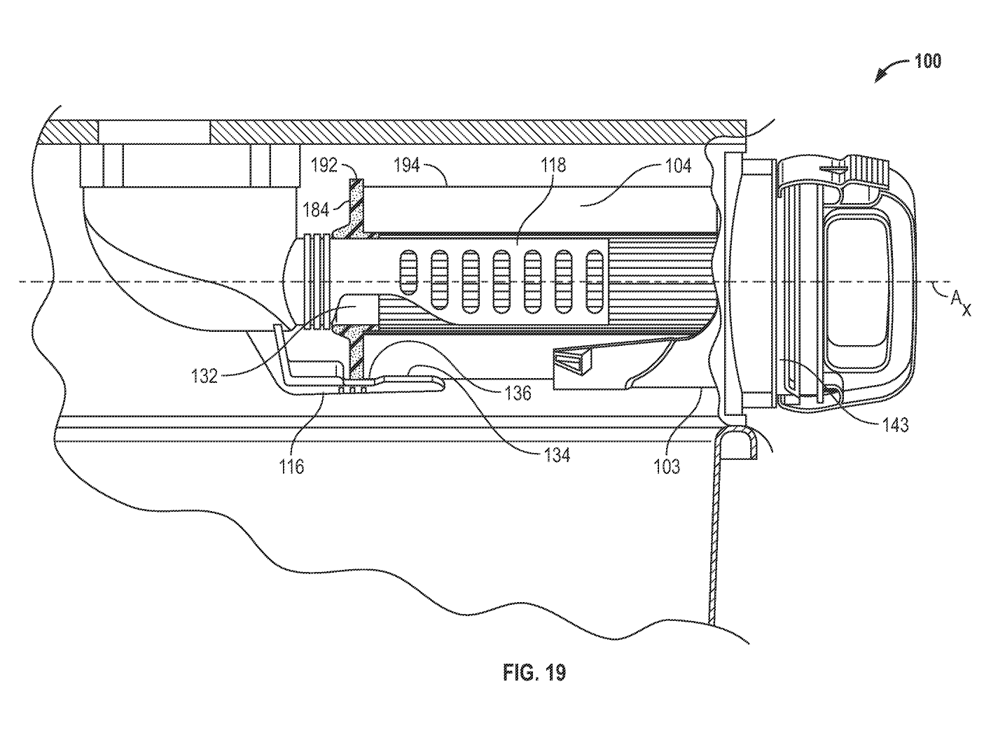

FIG. 16 is a top view of a filter assembly 103 partially uncoupled for cleaning or removal. FIG. 17 is a top view of filter assembly 103 being removed. FIG. 18 is another top view of the filter assembly of FIG. 17 being removed. FIG. 19 is a side view of a filter 104 being cleaned. FIGS. 16-19 will be described in conjunction with one another. To remove filter assembly 103, for example, for cleaning or replacement of filter 104, the installation process described above may be generally reversed, as will be understood by one of ordinary skill having the benefit of this disclosure. For example, to begin the removal process, latch 152 may be depressed to uncouple latch hook 170 and latch rib 158 and handle 164 may be pulled outwardly, or away, from filter inlet 108, such as to uncouple, or “unseat,” filter assembly 103 from one or more other components of filter system 100, such as filter inlet 108 and manifold 114.

If a user wishes to remove filter assembly 103 from vacuum cleaner body 106, latch 152 may route latch 152 through latch opening 144, such as by reversing the installation process described above with reference to FIGS. 16-18. Alternatively, filter assembly 103 may remain “partially” coupled to filter inlet 108 (e.g., as shown in FIG. 16), such as for optionally cleaning filter 104 while at least a portion of filter 104 remains inside vacuum cleaner body 106.

With reference to FIGS. 16 and 19, a method of cleaning filter 104, may now be described. From the fully installed position of filter assembly 103 (e.g., as shown in FIG. 15), for example, latch 152 may be depressed and filter assembly 103 may be uncoupled from filter inlet 108, such as to “unseat” filter assembly 103 from one or more other components of filter system 100. Latch hook 170 may, but need not, contact stop rib 160, such as, for example, to alert the user that latch hook 170 is in communication with cleaning slot 143 and may be arranged for optionally cleaning filter 104.

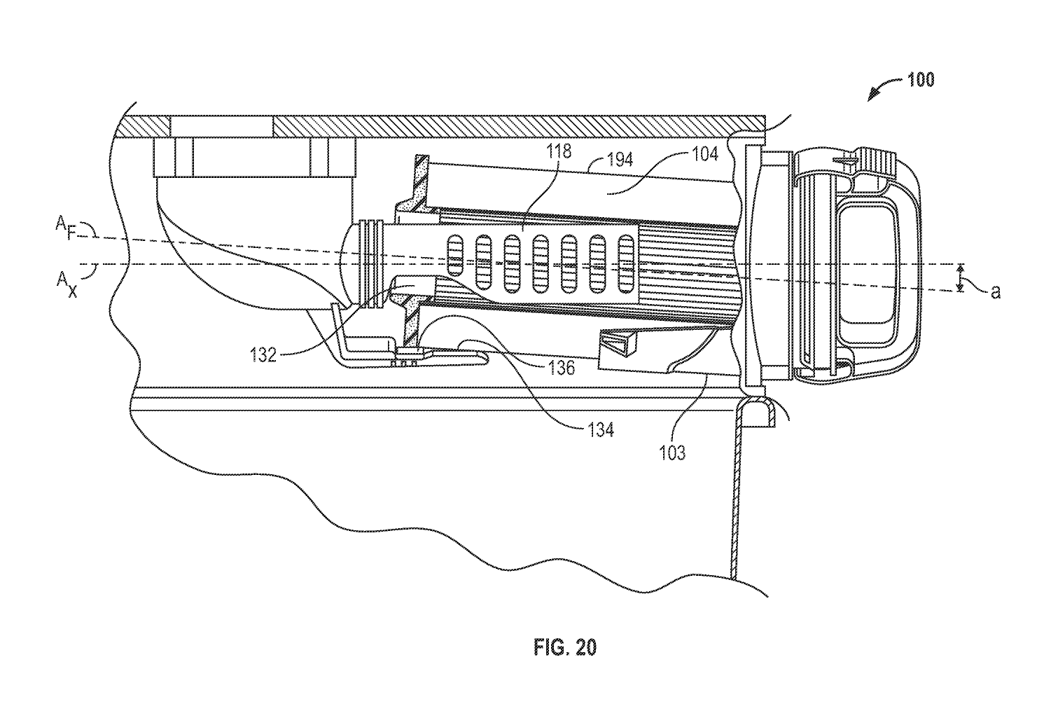

The user may grasp handle 164 and rotate filter assembly 103 about its central longitudinal axis A_{F}, which may be, but need not be, congruent with central longitudinal axis A_{X} of filter cage 118 (e.g., as shown in FIG. 20) Latch hook 170 may remain in sliding communication with cleaning slot 143, such as to guide filter assembly 103 during rotation. The rotation may occur in any direction, such as clockwise, counter-clockwise or both, for example, in an alternating fashion. A user may grasp handle 164 and rotate filter assembly 103 in any direction, with any speed, and over any angular distance, such as one rotation, a portion of a rotation, or more than one rotation.

As filter 104 begins to rotate, rubbing surface 136 of cleaning device 116 may communicate with a side 196 (e.g., as shown in FIG. 9A) of buffer surface 192 on first end 184 of filter 104, for example, to move filter 104 into a cleaning cycle position wherein at least a portion of cleaning surface 134 of cleaning device 116 may, but need not, contact at least a portion of filter element 194. As another example, a cleaning cycle position of filter 104 may include cleaning surface 134 being adjacent to, but not physically contacting, filter element 194. As filter 104 rotates about filter cage 118, cleaning device 116 may remain stationary, or substantially stationary with respect to the filter cage, and cleaning surface 134 may dislodge debris or other media from filter element 194. A component (such as the cleaning device 116) remains “substantially stationary” when it moves no more than 0.5 inches along any of its axes. The term “substantially stationary” can include a stationary or fixed position as well.

FIG. 20 is an illustration of one of many embodiments of filter system 100 having a cutout 132 and utilizing certain aspects of the present invention. At least one alternative method of cleaning filter 104, which is but one of many, may now be described with reference to FIG. 20. As described above with reference to FIG. 19, filter 104 may, but need not, be cleaned by rotating filter 104 about axis A_{X} of filter cage 118. In at least one other embodiment of the present invention, such as the one shown in FIG. 20, filter 104 may be disposed so that axes A_{X} and A_{F} are not congruent during cleaning. For example, filter assembly 103 may be tilted so that axis A_{F} of filter 104 and axis A_{X} of filter cage 118 form an angle α, which may be any angle, such as by disposing a portion of filter assembly 103 in cutout 132.

While one or more of the steps for cleaning may be generally the same as described above with reference to FIG. 19, rubbing surface 136 may cause at least a portion of first end 184 of filter 104 to shift into cutout 132 in one or more cleaning cycle positions. As another example, cutout 132 may allow a user to manipulate the position of filter 104 for cleaning as required by a particular application, which may, but need not, reduce one or more forces applied to filter 104, such as forces on filter element 194, during cleaning.

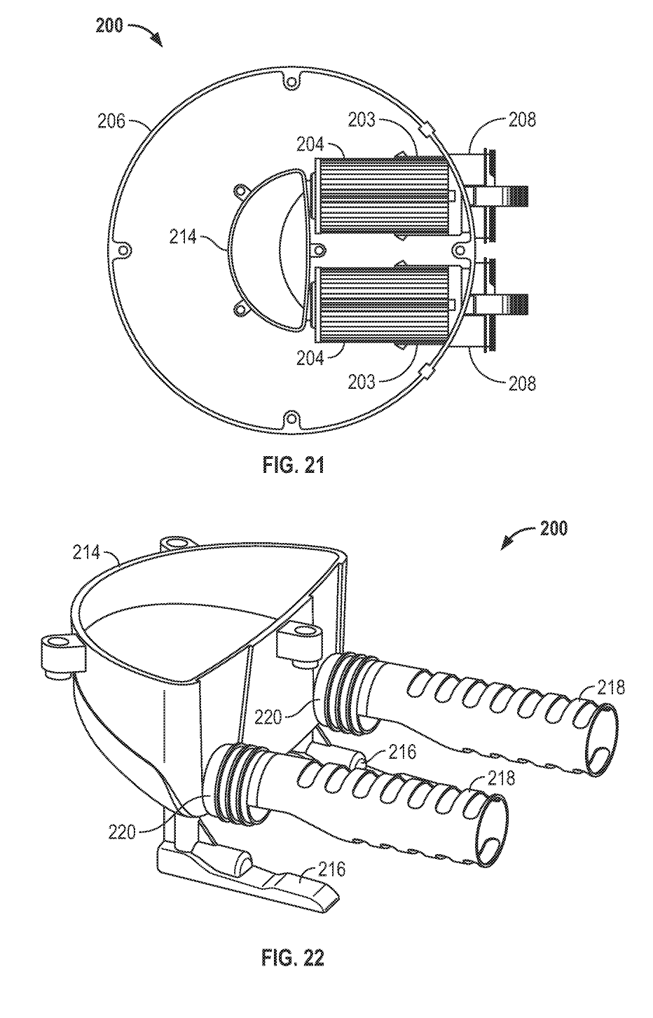

FIG. 21 is a top view of one of many embodiments of a filter system 200 having two filter assemblies 203 and utilizing certain aspects of the present invention. FIG. 22 is a top isometric view of one of many embodiments of a filter system 200 having two filter assemblies 203 and utilizing certain aspects of the present invention. FIGS. 21 and 22 will be described in conjunction with one another. In at least one embodiment of the present invention, filter system 200 may have more than one filter 204, for example, two filters 204, or any other number required by a particular application. As will be understood by one of ordinary skill having the benefit of this disclosure, one or more of the aspects described above with reference to FIGS. 1-20 may also apply to an embodiment having two or more filters 204 or filter assemblies 203, such as the embodiment of FIGS. 21 and 22, and therefore, need not be described again here.

Filter system 200 may include two or more filter cages 218, manifolds 214, cleaning devices 216, or other components. Manifold 214 may be a single manifold having two or more inlets 220, as shown for illustrative purposes in FIGS. 21 and 22, or alternatively, filter system 200 may include two or more separate manifolds 214. Filter inlets 208 may, but need not, be adjacent to one another, as shown in FIG. 21, and filter assemblies 203 may, but need not, be coupled to one another, as required by a particular application and as will be understood by one of ordinary skill having the benefit of this disclosure.

Other and further embodiments utilizing one or more aspects of the invention described above can be devised without departing from the spirit of Applicant's invention. For example, the one or more filter inlets may be located anywhere on the vacuum cleaner body, such as on the top, bottom, or side, singularly or in combination, and the one or more filters may be disposed horizontally, vertically, or angled relative to the air flowing through the system. Further, the various methods and embodiments of the filter system can be included in combination with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicant, but rather, in conformity with the patent laws, Applicant intends to fully protect all such modifications and improvements that come within the scope or range of equivalent of the following claims.

What is claimed is:

1. An apparatus for filtering a vacuum appliance's intake, the apparatus comprising:
a first end, wherein the first end comprises a first slot having a width;
a second end; and
a filter element adapted to be disposed between the first end and the second end;
wherein the filter element is further adapted to form a cavity having a length along a longitudinal axis of the apparatus, further wherein a width of the cavity spans a distance that is greater than or equal to the width of the first slot.

2. The apparatus for filtering a vacuum appliance's intake according to claim 1, wherein the second end comprises a second slot having a width equal to the width of the first slot.

3. The apparatus for filtering a vacuum appliance's intake according to claim 1, wherein the filter element is adapted to be formed into a shape comprising a plurality of crests and a plurality of troughs.

4. The apparatus for filtering a vacuum appliance's intake according to claim 3, wherein the plurality of crests and plurality of troughs form a plurality of pleats.

5. The apparatus for filtering a vacuum appliance's intake according to claim 3, wherein the width of the cavity is adapted to be formed by increasing a distance between two adjacent crests among the plurality of crests.

6. The apparatus for filtering a vacuum appliance's intake according to claim 5, wherein the cavity formed between the two adjacent crests and a trough disposed there between form a wedge-like shape.

7. The apparatus for filtering a vacuum appliance's intake according to claim 1, wherein the filter element disposed between the first end and the second end is adapted to be formed into a generally cylindrical shape.

8. A method of cleaning a vacuum appliance filter, the method comprising:
providing a filter, wherein the filter comprises a first end, a second end, and a filter element disposed between the first and second end;
providing a cleaning surface, wherein the cleaning element is adapted to be coupled to a filter cage; and
rotating the filter about the filter cage, wherein the rotating step causes debris or media to contact the cleaning surface.

9. The method of cleaning a vacuum appliance filter according to claim 8, further comprising providing a filter holder, wherein the filter holder is adapted to control the filter's rotation.

10. The method of cleaning a vacuum appliance filter according to claim 8, wherein the cleaning surface remains substantially stationary with respect to the filter cage throughout the step of rotating the filter.

11. The method of cleaning a vacuum appliance filter according to claim 8, wherein at least a portion of the filter holder is accessible from the outside of a vacuum appliance.

12. The method of cleaning a vacuum appliance filter according to claim 8, further comprising the step of coupling the filter to the filter cage.

13. The method of cleaning a vacuum appliance filter according to claim 8, wherein the rotating step dislodges the debris or media from the filter element.

14. The method of cleaning a vacuum appliance filter according to claim 8, wherein the cleaning surface is adapted to contact at least a portion of the filter element.

15. A system for receiving vacuumed debris, the system comprising:
a manifold comprising an inlet and an outlet, wherein the inlet is adapted to receive air filtered through a filter comprising a filter surface;
a filter cage, wherein the filter cage is adapted to be coupled to the outlet; and
a cleaning device, wherein the cleaning device further comprises a cleaning surface adapted to dislodge debris or media from the filter surface.

16. The system for receiving vacuumed debris according to claim 15, wherein the cleaning surface is adapted to be disposed between the cleaning device and the filter cage.

17. The system for receiving vacuumed debris according to claim 15, wherein the filter cage has a generally cylindrical shape with a longitudinal axis extending from the outlet.

18. The system for receiving vacuumed debris according to claim 17, wherein the cleaning device extends along an axis that is substantially parallel with the longitudinal axis extending from the outlet.

19. The system for receiving vacuumed debris according to claim 15, further comprising a filter, wherein the filter is adapted to be coupled to the filter cage.

20. The system for receiving vacuumed debris according to claim 15, wherein the filter cage further comprises a cutout region for regulating an amount of the filter element's surface area exposed through the filter cage.
